(19) United States
(12) Patent Application Publication
(10) Pub. No.: US 2018/0346713 A1
(43) Pub. Date: Dec. 6, 2018

(54) POLYLACTIC ACID RESIN COMPOSITION, AND PRODUCTION METHOD AND MOLDED BODY THEREOF

(71) Applicant: NEC CORPORATION, Tokyo (JP)

(72) Inventors: Makoto SOYAMA, Tokyo (JP); Masatoshi IJI, Tokyo (JP); Shukichi TANAKA, Tokyo (JP); Kiyohiko TOYAMA, Tokyo (JP)

(73) Assignee: NEC CORPORATION, Tokyo (JP)

(21) Appl. No.: 15/780,907

(22) PCT Filed: Dec. 2, 2016
(86) PCT No.: PCT/JP2016/085957

§ 371 Date: Jun. 1, 2018

(30) Foreign Application Priority Data
Dec. 4, 2015 (JP) 2015-238041

(51) Int. Cl. C08L 67/04; C08L 83/08; C08K 5/521; C08K 5/544

(52) U.S. Cl. CPC C08L 67/04; C08L 83/08; C08L 2201/02; C08K 5/544; C08K 5/521

(57) ABSTRACT

A polylactic acid resin composition according to an embodiment of the invention includes a polylactic acid resin, an aliphatic polyester resin, a carbodiimide compound and a metal hydrate, in which the metal hydrate is surface-treated with a specific silane coupling agent; and the carbodiimide compound includes an aliphatic carbodiimide compound.

### TECHNICAL FIELD

The present invention relates to a low fogging polylactic acid resin composition, and a production method and a molded body thereof.

### BACKGROUND ART

Polyhydroxycarboxylic acids including a polylactic acid have relatively excellent molding processability, toughness, rigidity and others. Of the polyhydroxycarboxylic acids, a polylactic acid can be synthesized from a natural raw material such as corn and has excellent molding processability, biodegradability and others. For the reason, a polylactic acid has been developed in various fields as an environmentally friendly resin.

However, a polylactic acid contains an extremely small amount of a low volatile component such as lactide, and a low volatile component is generated by thermal decomposition during a kneading/molding process. Because of these, particularly when a polylactic acid is used for applications requiring high fogging resistance, such as car trim parts, it has been required to take measures against fogging.

Fogging refers to a phenomenon where a substance contained in a material vaporizes at a high temperature and clouds cool glass. Particularly in automotive applications, visibility is reduced by fogging. Thus, it is necessary to suppress fogging.

Generally, a polylactic acid is flammable. When it is applied to uses requiring high flame retardance such as housings of household appliances and OA devices, and a car trim parts, measures to achieve flame retardance is required. For example, in the case where a polylactic acid resin is used for cases of electric appliances, the polylactic acid must satisfy the flame retardant standard such as UL standards of U.S.A.

A polylactic acid has excellent physical properties; whereas the polylactic acid is inferior in impact resistance and flexibility such as bending breaking strain, compared to resins derived from oil, such as an ABS resin. Because of this, it is difficult to use a polylactic acid in exterior materials for electrical/electronic devices and car trim parts requiring high impact resistance.

Patent Literature 1 describes a biodegradable resin composition containing a polylactic acid and a silicone-lactic acid copolymer for improving e.g., impact resistance and flame retardance. However, the biodegradable resin composition has a problem in that a step of preparing a silicone-lactic acid copolymer is complicated. In addition, although the biodegradable resin composition has satisfactory flame retardance, impact resistance thereof is insufficient compared to resins so far used in electronic/electrical devices. Because of this, the biodegradable resin composition is unfavorable for use in utility goods. In addition, fogging is not taken into consideration.

Patent Literature 2 describes a polylactic acid resin composition containing a polylactic acid resin, a low-sodium content metal hydroxide whose surface is treated with a silane coupling agent, a plasticizer and a phosphorus compound for improving impact resistance and flexibility. The resin composition has flame retardance and impact resistance; however, fogging is not taken into consideration. Since a highly volatile plasticizer is used, the resin composition is not often used in practice for applications such as automotive parts, requiring measures against fogging.

Patent Literature 3 describes a resin composition containing a polylactic acid resin, a polycarbonate resin and an amino group-containing chain extender, for providing an environment-friendly resin composition improved in, e.g., heat resistance, mechanical strength and hydrolysis resistance. According to the description, in the resin composition, desired physical properties are obtained by increasing viscosity of the polylactic acid resin with the amino group-containing chain extender to control morphology with a polycarbonate resin. However, in the resin composition, since high flowability, which is a characteristic feature of a polylactic acid resin, is inhibited, the resin composition is not suitable for forming a thin wall. In addition, the resin composition contains a petroleum-derived polycarbonate resin as an essential component. Because of this, the resin composition has poor environmental harmony.

### CITATION LIST

### Patent Literature

Patent Literature 1: JP2004-277575A
Patent Literature 2: WO2009/125872
Patent Literature 3: JP2009-293031A

### SUMMARY OF INVENTION

### Technical Problem

An object of the present invention is to provide a polylactic acid resin composition having high fogging resistance and flame retardance, and excellent impact resistance and flexibility, and a molded body thereof.

### Solution to Problem

According to one aspect of the present invention, there is provided a polylactic acid resin composition comprising a polylactic acid resin, an aliphatic polyester resin, a carbodiimide compound and a metal hydrate, in which

the metal hydrate is a metal hydrate surface-treated with an aminosilane coupling agent, a ureide silane coupling agent, an isocyanate silane coupling agent or an epoxy silane coupling agent, and

the carbodiimide compound comprises an aliphatic carbodiimide compound.

According to another aspect of the present invention, there is provided a molded body formed by using the polylactic acid resin composition.

According to another aspect of the present invention, there is provided a method for producing a polylactic acid resin composition, the method comprising a step of mixing and stirring a mixture comprising a molten-state polylactic acid compound, an aliphatic polyester resin, a carbodiimide compound and a metal hydrate, in which

the metal hydrate is a metal hydrate surface-treated with an aminosilane coupling agent, a ureide silane coupling agent, an isocyanate silane coupling agent or an epoxy silane coupling agent, and

the carbodiimide compound comprises an aliphatic carbodiimide compound.

In the aforementioned production method, it is preferable that an amino group-containing polysiloxane compound having an amino group in a side chain is further added, mixed and stirred.

It is preferable that the content of the amino group is in the range of 0.01% by mass to 2.5% by mass with respect to the amino group-containing polysiloxane compound, and that, the content of the amino group is in the range of 3 ppm by mass to 300 ppm by mass with respect to the polylactic acid compound.

### Advantageous Effects of Invention

According to an exemplary embodiment, it is possible to provide a polylactic acid resin composition having high fogging resistance and flame retardance, and excellent impact resistance and flexibility, and a molded body thereof.

### BRIEF DESCRIPTION OF DRAWING

FIG. 1 is an illustrative drawing of a tester used for fogging evaluation.

### DESCRIPTION OF EMBODIMENTS

The present inventors conducted intensive studies for improving fogging resistance, flame retardance, impact resistance and flexibility (e.g., bending breaking strain) of a polylactic acid resin. As a result, they found that a polylactic acid resin composition containing a polylactic acid resin, an aliphatic polyester resin, a carbodiimide compound and a metal hydrate has excellent fogging resistance, flame retardance, impact resistance and satisfactory flexibility such as bending breaking strain, by using a metal hydrate whose surface is treated with an aminosilane coupling agent, a ureide silane coupling agent, an isocyanate silane coupling agent or an epoxy silane coupling agent as the metal hydrate, and an aliphatic carbodiimide compound as the carbodiimide compound.

They further found that if a phosphorus flame retardant is blended with the polylactic acid resin composition, further higher flame retardance is obtained while maintaining excellent fogging resistance, impact resistance, satisfactory flexibility such as bending breaking strain.

As the polylactic acid resin, a modified polylactic acid resin obtained by reacting a polylactic acid compound with an amino group-containing polysiloxane compound can be used. More specifically, the modified polylactic acid resin can be obtained by melting and mixing an amino group-containing polysiloxane compound and an unmodified polylactic acid resin (a polylactic acid compound) before reacting with the amino group-containing polysiloxane compound.

Note that the polylactic acid resin composition according to the exemplary embodiment may contain an unmodified polylactic acid resin (a polylactic acid compound) as the polylactic acid resin; however, in order to obtain further excellent impact resistance and satisfactory flexibility such as bending breaking strain, the modified polylactic acid resin is preferably contained as the polylactic acid resin.

The reason why the polylactic acid resin composition according to an exemplary embodiment exhibits particularly fogging resistance (low fogging) is considered that fogging is suppressed because a low volatile component, such as lactide, lactic acid, and a low molecular weight polylactic acid resin that are generated from a polylactic acid resin, is trapped by a carbodiimide compound, and a low volatile component generated from a polylactic acid resin is further trapped by a polyester resin through a transesterification reaction. However, these mechanisms are just estimated and do not limit the present invention.

The reason why the polylactic acid resin composition exhibits particularly excellent mechanical properties such as impact resistance is considered because a polyester-polylactic acid copolymer is formed by a transesterification reaction between the aliphatic polyester resin and the polylactic acid resin. The presence of the polyester-polylactic acid copolymer is considered to be able to impart excellent impact resistance and satisfactory flexibility such as bending breaking strain to a molded article of such a polylactic acid resin composition. Note that, these mechanisms are just estimated and do not limit the present invention.

Such a polylactic acid resin composition is preferably obtained by melting and mixing a material containing a polylactic acid resin, an aliphatic polyester resin, a metal hydrate and a carbodiimide compound. The “melting and mixing” herein means that at least a polylactic acid resin and an aliphatic polyester resin are mixed in a molten state. Through the melting and mixing step, a polyester-polylactic acid copolymer can be formed.

In the polylactic acid resin composition, if a polylactic acid resin has a segment of an amino group-containing polysiloxane compound and a segment of a polylactic acid compound, it is considered that the segments are mutually bound to form a polysiloxane-polylactic acid copolymer (modified polylactic acid resin). Since the polysiloxane-polylactic acid copolymer is present, it is considered that a molded article of such a polylactic acid resin composition can acquire excellent impact resistance and satisfactory flexibility such as bending breaking strain. Note that the polysiloxane-polylactic acid copolymer is conceivably produced by the reaction between an amino group of the amino group-containing polysiloxane compound and an ester group (ester binding moiety) of the polylactic acid compound.

The polylactic acid resin composition is also excellent in fogging resistance and bleed resistance. Originally, a polylactic acid compound and a polysiloxane compound are poor in compatibility, with the result that dispersibility is poor and bleed and fogging are likely to occur. However, in the polylactic acid resin composition, a polysiloxane compound having a specific amount of an amino group and a polylactic acid compound are reacted to form a polysiloxane-polylactic acid copolymer in which a specific amount of a polysiloxane compound is introduced into the polylactic acid compound. The polysiloxane-polylactic acid copolymer forms into silicone elastomer particles, which are satisfactorily dispersed in the polylactic acid resin composition and satisfactorily bound to the interface of the polylactic acid resin. Because of this, it is considered that a molded article of the polylactic acid resin composition can acquire fogging resistance and bleed resistance. Note that, these mechanisms are just estimated and do not limit the present invention.

Such a polylactic acid resin composition is preferably obtained by melting and mixing a material containing a polylactic acid compound, an amino group-containing polysiloxane compound, an aliphatic polyester resin, a metal hydrate and a carbodiimide compound. The “melting and mixing” herein means that at least a polylactic acid compound, an amino group-containing polysiloxane compound and an aliphatic polyester resin are mixed in a molten state. In the step of melting and mixing, a modified polylactic acid resin (polysiloxane-polylactic acid copolymer) can be formed and further, a reaction product between the modified polylactic acid resin and an aliphatic polyester resin (polyester-polylactic acid copolymer) is formed.

In the segment of the amino group-containing polysiloxane compound, it is preferable that an amino group is bound to a side chain of the polysiloxane compound. In the amino group-containing polysiloxane compound having an amino group in a side chain, the concentration (density) of an amino group is easily controlled and the reaction with the segment of the polylactic acid compound is readily controlled. Particularly, the amino group is preferably a diamino group, because reactivity of the diamino group with a polylactic acid compound is higher than a monoamino group.

It is necessary that the content of the amino group with respect to the amino group-containing polysiloxane compound is in the range where the molecular weight of the amino group-containing polysiloxane compound is increased while maintaining the reactivity of the segment of the polylactic acid compound, and where volatilization of the amino group-containing polysiloxane compound can be suppressed at the time of production. The content of the amino group is in the range of 0.01% by mass to 2.5% by mass and preferably 0.01% by mass to 1.0% by mass. If the content of the amino group is 0.01% by mass or more, an amide bond with the segment of the polylactic acid compound can be sufficiently formed and the copolymer can be efficiently produced, and bleeding in a molded article caused by separation of a polysiloxane segment can be suppressed. If the content of the amino group is 2.5% by mass or less, not only hydrolysis of the polylactic acid compound at the time of production but also aggregation can be suppressed, with the result that a molded article having a high mechanical strength and a uniform composition can be obtained.

The content of the amino group can be determined by the following expression (I).

Content of amino group (% by mass)=(16/amino equivalent)×100 (I)

where the amino equivalent: an average value (g/mol) of the mass of the amino group-containing polysiloxane compound per mole of the amino group.

The blend amount of the amino group with respect to the polylactic acid compound falls preferably within the range of 3 ppm by mass to 300 ppm by mass and more preferably within the range of 50 ppm by mass to 300 ppm by mass. If the blend amount of the amino group is 3 ppm by mass or more, the impact resistance of a molded article due to the segment of the amino group-containing polysiloxane compound can be improved. If the blend amount of the amino group is 300 ppm by mass or less, it is easy to disperse the polylactic acid compound and the amino group-containing polysiloxane compound at the time of production, with the result that the molecular weight of the polylactic acid resin is suppressed from markedly decreasing, and a molded article excellent in mechanical strength such as impact strength can be obtained.

The blend amount of the amino group can be determined by the following expression (II).

Blend amount of the amino group (ppm by mass)=100×a content of the amino group with respect to the amino group-containing polysiloxane compound (% by mass)×a ratio of the amino group-containing polysiloxane compound to the polylactic acid compound (% by mass) (II)

Such an amino group-containing polysiloxane compound constituting a segment is preferably an amino group-containing polysiloxane compound easily binding to the segment of the polylactic acid compound in mild conditions without using special means. As such an amino group-containing polysiloxane compound, for example, those represented by the following Formula (1) and the following Formula (2) can be mentioned.

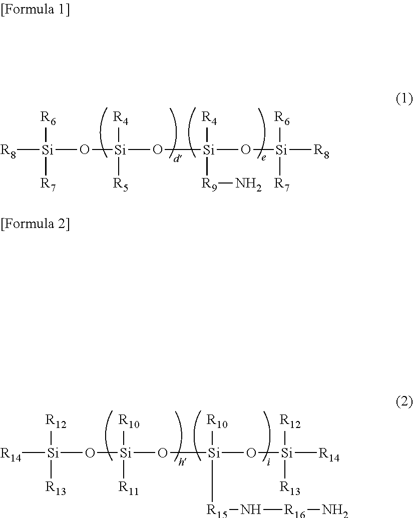

In the Formulas (1) and (2), R₄ to R₈ and R₁₀ to R₁₄ each independently represent an alkyl group, an alkenyl group, an aryl group, an aralkyl group, an alkylaryl group having 18 or less carbon atoms or —(CH₂)_{α}—NH—C₆H₅ (α represents an integer of 1 to 8); these may be fully or partially substituted with a halogen atom(s); R₉, R₁₅ and R₁₆ each independently represent a bivalent organic group; d′ and h′ each represent an integer of 0 or more; and e and i each represent an integer of 1 or more.

As the alkyl group, e.g., a methyl group, an ethyl group, a propyl group, a butyl group and a t-butyl group are preferable. As the alkenyl group, e.g., a vinyl group is preferable. As the aryl group, e.g., a phenyl group and a naphthyl group are preferable. As the alkylaryl group, e.g., a benzyl group can be mentioned. As the halogen atom, e.g., chlorine, fluorine, bromine are mentioned. Examples of the groups having a halogen substituent that can be mentioned include a chloromethyl group, a 3,3,3-trifluoromethyl group, a perfluorobutyl group and a perfluorooctyl group. It is preferable that R₄ to R₈ and R₁₀ to R₁₄ are each particularly a methyl group or a phenyl group.

The phenyl group has a function to improve the transparency of a segment of a polysiloxane compound. The refractive index of the polylactic acid resin can be controlled by controlling the content of the phenyl group. If the refractive index of a segment of a polysiloxane compound is matched with the refractive index of a segment of the polylactic acid compound, a molded article uniform in refractive index can be obtained and a molded article having a desired transparency can be obtained.

As the bivalent organic group, for example, an alkylene group such as a methylene group, an ethylene group, a propylene group and a butylene group, an alkylarylene group such as a phenylene group and a tolylene group; an oxyalkylene group or a polyoxyalkylene group such as —(CH₂—CH₂—O)_{b}— (b represents an integer of 1 to 50), —[CH₂—CH(CH₃)—O]_{c}— (c represents an integer of 1 to 50) and —(CH₂)_{d}—NHCO— (d represents an integer of 1 to 8) can be mentioned. Of these, particularly R₁₆ is preferably an ethylene group; and R₉ and R₁₅ are preferably a propylene group.

Reference symbols, d′, h′, e and i, are preferably values to give a number average molecular weight of the polysiloxane compound within the range described later. Reference symbols, d′ and h′, each represent an integer of preferably 1 to 15000, an integer of more preferably 1 to 400, and an integer of further preferably 1 to 100. Reference symbols, e and i are each preferably in the range of 1 to 15000, and more preferably an integer satisfying that the content of the amino group with respect to the amino group-containing polysiloxane compound determined by the expression (I) is in the range of 0.01% by mass to 2.5% by mass.

In the amino group-containing polysiloxane compounds represented by the Formulas (1) and (2), repeating units repeated according to the numbers of the repeating units d′, h′, e and i, respectively, may be connected with same repeating units being continuously connected, or may be connected alternately, or may be connected randomly.

The number average molecular weight of the amino group-containing polysiloxane compound preferably is in the range of 900 to 120000. If the number average molecular weight is 900 or more, it is possible to suppress a loss by volatilization in a kneading step with a molten polylactic acid compound in producing of the polylactic acid resin. If the number average molecular weight is 120000 or less, a uniform molded article having satisfactory dispersibility can be obtained. The number average molecular weight falls more preferably within the range of 900 to 20000 and further preferably within the range of 900 to 8000.

As the number average molecular weight, a measurement value (calibrated with polystyrene standard samples) measured, for example, by GPC (gel permeation chromatography) analysis of a 0.1% chloroform solution of a sample.

As the segment of the amino group-containing polysiloxane compound, a segment of a polysiloxane compound having an amino group at an end of the main chain may be included as long as the function of the amino group-containing polysiloxane compound is not inhibited, further, a segment of, e.g., a polysiloxane compound containing no amino group may be included. The contents of the polysiloxane compound having an amino group at an end of the main chain and the polysiloxane compound containing no amino group (the sum when both compounds are contained) preferably fall within the range of 0% by mass to 5% by mass of the amino group-containing polysiloxane compound. The number average molecular weights of a polysiloxane compound having an amino group at an end of the main chain and the polysiloxane compound containing no amino group preferably fall within the range of 900 to 120000.

As the amino group-containing polysiloxane compound, a polysiloxane compound having a diamino group in a side chain and represented by Formula (2) is more preferable than a polysiloxane compound having a monoamino group in a side chain and represented by Formula (1), because the polysiloxane compound having a diamino group in a side chain and represented by Formula (2) is excellent in reactivity and quickly reacts with a polylactic acid compound during kneading in a molten state.

As the polylactic acid compound to be contained as an unmodified polylactic acid resin in the polylactic acid resin composition according to the exemplary embodiment and the polylactic acid compound constituting the segment of the polylactic acid compound to be contained in the modified polylactic acid resin, extracts of polylactic acid compounds obtained from biomass raw materials, derivatives thereof, or modified compounds thereof; polycondensates synthesized by using monomers, oligomers, derivatives thereof or modified compounds thereof of lactic acid compounds obtained from biomass raw materials; and additionally polylactic acid compounds synthesized by using raw materials other than biomass raw materials. Examples of such polylactic acid compounds include a compound represented by the following formula (3)

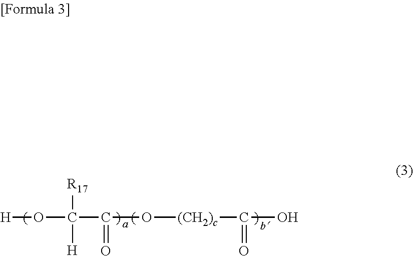

In the Formula (3), R₁₇ represents an alkyl group having 18 or less carbon atoms; a and c represent an integer of 1 or more; and b′ represents an integer of 0 or more.

Reference symbol a preferably represents an integer of 500 to 13000 and more preferably an integer of 1500 to 4000. Reference symbol b′ preferably represents an integer of 0 to 5000. Reference symbol c preferably represents an integer of 1 to 50. In a polylactic acid compound represented by the Formula (3), repeating units repeated according to the numbers of the repeating units a and b′, respectively, may be connected with the same repeating units being continuously connected, or may be connected alternately.

Examples of the polylactic acid compound represented by the Formula (3) that can be mentioned include L-lactic acid, D-lactic acid and polymers of these derivatives and a copolymer principally formed of these. Examples of such a copolymer that can be mentioned include a copolymer obtained from L-lactic acid, D-lactic acid and/or these derivatives, and one or two or more of e.g., glycolic acid, polyhydroxybutyric acid, polycaprolactone, polybutylene succinate, polybutylene succinate adipate, polyethylene succinate, polybutylene adipate terephthalate, polybutylene succinate terephthalate and polyhydroxyalkanoate.

Among these, from the viewpoint of saving petroleum resources, the polylactic acid compounds using raw materials originated from plants are preferable; and in terms of heat resistance and moldability, especially preferable are poly(L-lactic acid), poly(D-lactic acid), and copolymers of L-lactic acid and D-lactic acid. Polylactic acids made from poly(L-lactic acid) as a main component have different melting points depending on the ratio of the D-lactic acid component, but it is preferable in consideration of the mechanical properties and the heat resistance of molded articles that the polylactic acid compound represented by the formula (3) be one having a melting point of 160° C. or higher.

The weight-average molecular weight (in terms of standard polystyrenes by gel permeation chromatography (GPC)) of the polylactic acid compound is preferably in the range of 30,000 to 1,000,000, and more preferably in the range of 50,000 to 300,000.

Examples of the aliphatic polyester resin include polybutylene succinate, polybutylene succinate adipate and polycaprolactone. The aliphatic polyester resin has a number-average molecular weight (in terms of standard polystyrene by GPC), not especially limited, of for example, 10,000 to 100,000, preferably 30,000 to 90,000, and more preferably 30,000 to 70,000; and a weight-average molecular weight (in terms of standard polystyrene by GPC), not especially limited, of for example, 20,000 to 200,000, preferably 40,000 to 190,000, and more preferably 100,000 to 180,000. The aliphatic polyester resin may satisfy, for example, both of the above number-average molecular weight and the above weight-average molecular weight, or either one thereof. It is preferable that such an aliphatic polyester resin be polybutylene succinate adipate.

The content (blend amount) of the polylactic acid resin with respect to the total amount of the polylactic acid resin composition is, from the viewpoint of sufficiently attaining the desired effect by the exemplary embodiment of the present invention, preferably 25% by mass or higher and 60% by mass or lower, and more preferably 30% by mass or higher, and then more preferably 55% by mass or lower and still more preferably 50% by mass or lower.

Here, the content (blend amount) of the polylactic acid resin, in the case where the polylactic acid resin composition according to the present exemplary embodiment comprises the polylactic acid compound (unmodified polylactic acid resin) as the polylactic acid resin, means a blend amount of the polylactic acid compound, and in the case of comprising the modified polylactic acid resin as the polylactic acid resin, means a blend amount of the polylactic acid compound corresponding to the segment of the polylactic acid compound constituting the modified polylactic acid resin.

The content (blend amount) of the amino group-containing polysiloxane compound with respect to the total amount of the polylactic acid resin composition can be set at 0% by mass or higher and 5% by mass or lower, and from the viewpoint of sufficiently attaining the effect by the amino group-containing polysiloxane compound, is preferably 0.1% by mass or higher, more preferably 0.5% by mass or higher, still more preferably 1% by mass or higher, and particularly from the viewpoint of improving flame retardancy, is preferably 1.5% by mass or higher. The content is allowed to exceed 5% by mass, but attaining the improving effect corresponding to the content becomes difficult.

Here, the content (blend amount) of the amino group-containing polysiloxane compound includes a blend amount of the amino group-containing polysiloxane compound corresponding to the segment of the amino group-containing polysiloxane compound constituting the modified polylactic acid resin. Further in the case where the amino group-containing polysiloxane compound reacts with the ester group (ester bond) of the aliphatic polyester resin, the content (blend amount) includes a blend amount of the amino group-containing polysiloxane compound corresponding to the segment of the amino group-containing polysiloxane compound constituting the reaction product. That is, the content (blend amount) of the amino group-containing polysiloxane compound includes, irrespective of kinds of components bound in the polylactic acid resin composition, the amino group-containing polysiloxane compound corresponding to the segment of the amino group-containing polysiloxane compound.

The content (blend amount) of the aliphatic polyester resin with respect to the total amount of the polylactic acid resin composition, from the viewpoint of sufficiently attaining the desired effect by the exemplary embodiment of the present invention, preferably 0.05% by mass or higher and 40% by mass or lower. When the content is lower than 0.05% by mass, a sufficient improving effect of the impact resistance cannot be attained; and when the content exceeds 40% by mass, it becomes difficult to attain an improving effect of the impact resistance corresponding to the increase, even if the addition amount is increased. The content of the aliphatic polyester resin is more preferably 1% by mass or higher and still more preferably 5% by mass or higher, and more preferably 30% by mass or lower, still more preferably 20% by mass or lower.

The carbodiimide compound includes polycarbodiimide compounds and monocarbodiimide compounds. The polycarbodiimide compounds include ones having a fundamental structure of the following general formula (4).

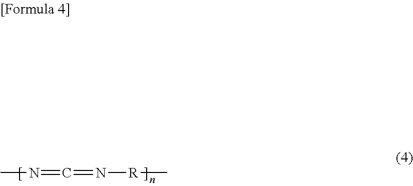

In the Formula (4), n represents an integer of 2 or more; R represents an aliphatic or aromatic organic group consisting of C and H. As the aliphatic organic group, an alicyclic organic group is preferable. Reference symbol n is preferably 2 to 50. For example, a polycarbodiimide where n is in the range of 2 to 20 can be used; and further a polycarbodiimide where n is in the range of 5 to 20 can be used.

With respect to the carbodiimide compound, one synthesized by a commonly well-known method can be used. As the carbodiimide compound, there can be used, for example, one synthesized by subjecting various organic diisocyanates to a decarbonation condensation reaction solventless or in an inert solvent at a temperature of about 70° C. or higher using an organphosphorus compound or an organometal compound as a catalyst.

As an organic diisocyanate of a raw material for producing a polycarbodiimide compound, there can be used one selected from aliphatic diisocyanates (preferably alicyclic diisocyanates), aromatic diisocyanates and mixtures of two or more thereof. Specific examples thereof include 1,5-naphthalene diisocyanate, 4,4′-diphenylmethane diisocyanate, 4,4′-diphenyldimethylmethane diisocyanate, 1,3-phenylene diisocyanate, 1,4-phenylene diisocyanate, 2,4-tolylene diisocyanate, 2,6-tolylene diisocyanate, hexamethylene diisocyanate, cyclohexane-1,4-diisocyanate, xylylene diisocyanate, isophorone diisocyanate, dicyclohexylmethane-4,4′-diisocyanate, methylcyclohexane diisocyanate, tetramethylxylylene diisocyanate, 3,3′,5,5′-tetraisopropylbiphenyl-4,4′-diisocyanate and 1,3,5-triisopropylbenzene-2,4-diisocyanate. Of these, in view of improvement of fogging resistance, an aliphatic diisocyanate having high reactivity is preferable and an alicyclic diisocyanate is more preferable.

The monocarbodiimide includes dicyclohexylcarbodiimide, diisopropylcarbodiimide, diphenylcarbodiimide, bis(methylphenyl)carbodiimide, bis(methoxyphenyl)carbodiimide, bis(nitrophenyl)carbodiimide, bis(dimethylphenyl)carbodiimide, bis(diisopropyl)carbodiimide, bis(t-butyl)carbodiimide, N-ethyl-N′-(3-dimethylaminopropyl)carbodiimide, bis(triphenylsilyl)carbodiimide and N,N′-di-2,6-diisopropylphenylcarbodiimide.

The polycarbodiimide includes aliphatic polycarbodiimides such as poly(4,4′-dicyclohexylmethanecarbodiimide); and aromatic polycarbodiimides such as poly(4,4′-diphenylmethanecarbodiimide), poly(p-phenylenecarbodiimide), poly(m-phenylenecarbodiimide), poly(methylphenylenecarbodiimide), poly(diisopropylphenylenecarbodiimide), poly(methyl-diisopropylphenylenecarbodiimide), poly(1,3,5-triisopropylphenylenecarbodiimide), and poly(1,3,5-triisopropylphenylene and 1,5-diisopropylphenylenecarbodiimide).

As the aliphatic polycarbodiimide, preferable are aliphatic polycarbodiimides having an alicyclic structure such as a cyclohexane ring. Examples thereof include polycarbodiimides in which the organic linkage group R of the above general formula contains at least a divalent alicyclic group such as a cyclohexylene group. As such an aliphatic polycarbodiimide, there can suitably be used a poly(4,4′-dicyclohexylmethanecarbodiimide). As a commercially available product of the poly(4,4′-dicyclohexylmethanecarbodiimide), Carbodilite LA-1 (trade name), manufactured by Nisshinbo Chemical Inc., can be used.

The aromatic polycarbodiimide includes polycarbodiimides which have an aromatic structure such as a benzene ring, and for example, in which the organic linkage group R of the above general formula contains at least a substituted or unsubstituted phenylene group. The substituent of the phenylene group is preferably an alkyl group having 1 to 6 carbon atoms, and more preferably an alkyl group having 1 to 4 carbon atoms. The alkyl group includes a methyl group, an ethyl group, a propyl group (n-propyl group, isopropyl group), a butyl group (n-butyl group, isobutyl group, sec-butyl group, tert-butyl group), a straight-chain or branched pentyl group, a straight-chain or branched hexyl group and a cyclohexyl group. The phenylene group may have a plurality of substituents.

The carbodiimide compound may be used singly or in a combination of two or more. Further, a monocarbodiimide compound and a polycarbodiimide compound may be used concurrently, and an aliphatic carbodiimide compound and an aromatic carbodiimide compound may be used concurrently.

The content of the carbodiimide compound with respect to a total amount of the polylactic acid resin composition is preferably 0.1% by mass or more and 10% by mass or less in order to sufficiently obtain the effect of the present invention. If the content is less than 0.1% by mass, sufficient hydrolysis resistance and an effect of improving fogging resistance cannot be obtained. In contrast, if the content is beyond 10% by mass, even if the addition amount is increased, an effect of improving hydrolysis resistance corresponding to the increased amount cannot be obtained. The content is more preferably 0.2% by mass or more, and further preferably 0.5% by mass or more; and more preferably 5% by mass or less and further preferably 3% by mass or less. In view of fogging resistance, as the carbodiimide, an aliphatic carbodiimide compound is preferably included. As the aliphatic carbodiimide compound, an alicyclic carbodiimide compound is preferable. It is more preferable that an aliphatic carbodiimide compound and an aromatic carbodiimide compound are used in combination. The mixing ratio (mass ratio) of an aliphatic carbodiimide and an aromatic carbodiimide is preferably 9/1 to 1/9, more preferably 7/3 to 3/7 and further preferably 6/4 to 4/6.

The polylactic acid resin composition according to an exemplary embodiment further comprises the metal hydrate. In the metal hydrate, from the viewpoint of suppressing the hydrolysis of the polylactic acid resin, the content of an alkali metal substance in the metal hydrate is preferably 0.2% by mass or lower. The alkali metal substance refers to an oxide or a chloride of an alkali metal such as lithium, sodium or potassium, or an alkaline earth metal such as beryllium, magnesium, calcium, strontium or barium. The content of the alkali metal substance can be measured, for example, by atomic absorption spectrometry, ICP atomic emission spectrometry or the like.

Examples of the metal hydrate include aluminum hydroxide, magnesium hydroxide, dawsonite, calcium aluminate, hydrated gypsum, calcium hydroxide, zinc borate, barium metaborate, borax, kaolin clay and calcium carbonate; and preferable are aluminum hydroxide, magnesium hydroxide and calcium hydroxide, and more preferable is aluminum hydroxide.

Then it is preferable that the metal hydrate be made of granular bodies of 10 μm or smaller in average particle diameter; and it is more preferable that the metal hydrate be made of granular bodies of 0.1 μm to 5 μm in average particle diameter. Here, the average particle diameter of the metal hydrate can be determined, for example, by measuring a median diameter in terms of volume by a diffraction scattering method. Examples of commercially available instruments capable of measuring the average particle diameter include a laser diffraction scattering particle size analyzer LS230, manufactured by Beckman Coulter, Inc.

It is preferable that the metal hydrate be one surface-treated with a silane coupling agent. A method of obtaining a metal hydrate surface-treated with a silane coupling agent is not especially limited, and examples thereof include a method of spraying or coating a solution in which a silane coupling agent is dissolved in a solvent such as acetone, ethyl acetate or toluene on a surface of the metal hydrate having an alkali metal substance content of 0.2% by mass or lower, and thereafter drying to remove the solvent. Among surface-treated metal hydrates, metal hydrates modified particularly with an aminosilane, a ureidosilane, an isocyanate silane or an epoxysilane are excellent in adhesivity with the polylactic acid resin and can simultaneously satisfy both excellent flame retardancy and impact resistance.

As the metal hydrate surface-treated with a silane coupling agent, there can be used one treated with the silane coupling agent in a mass ratio thereof to the metal hydrate before the treatment of 0.1 to 5.0% by mass; and the mass ratio is, from the viewpoint of attaining a sufficient surface treatment effect, preferably 0.3% by mass or higher, and more preferably 0.5% by mass or higher, and from the viewpoint of attaining a surface treatment effect at a reaction ratio as high as possible, preferably 3% by mass or lower, and more preferably 2% by mass or lower.

In the case of carrying out the surface treatment using a surface treating agent, a common method can be used such as a dry-type method, a wet-type method, a spray system or an integral blend system. Specifically, there can be used the dry-type method in which a surface treating agent is sprayed with dry air or nitrogen gas for the treatment while the metal hydrate is stirred using a V-blender or the like; the wet-type method in which a surface treating agent is added for the treatment when the metal hydrate has been dispersed in water and has made a slurry state; the spray system in which a surface treating agent is sprayed for the treatment after the metal hydrate is heated in a high-temperature furnace; the integral blend system in which the metal hydrate, other resin materials and a surface treating agent are simultaneously charged in an extruder for the treatment; and the like.

Here, with respect to the surface treating agent to be used in the dry-type method, the wet-type method and the spray system, the surface treating agent may be used as it is, or may be diluted with an organic solvent (or water) and used as a solution.

The content of the metal hydrate with respect to the polylactic acid resin composition falls preferably within the range of 1% by mass to 50% by mass, more preferably within the range of 5% by mass to 45% by mass, and further preferably within the range of 10% by mass to 45% by mass. If the content of the metal hydrate is 1% by mass or more, a sufficient flame retardance effect can be obtained. If the content of the metal hydrate is 50% by mass or less, a decrease of mechanical properties can be prevented. Particularly, the content of the metal hydrate with respect to the polylactic acid resin composition falls preferably within the range of 30% by mass to 50% by mass and more preferably within the range of 35% by mass to 50% by mass.

The polylactic acid resin composition according to an exemplary embodiment may further contain a flame retardant. As the flame retardant, a flame retardant known in the art can be used; however, a phosphorus flame retardant is preferable, a phosphazene derivative and an aromatic condensed phosphoric acid ester are more preferable since they are excellent in flame retardance effect. As the phosphazene derivative, for example, a cyclic cyclophosphazene compound represented by the following formula is mentioned.

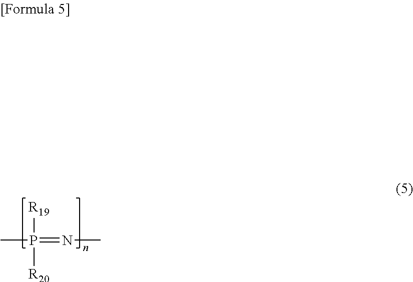

Where n represents an integer of 3 or more, preferably is in the range of 3 to 25 and more preferably within the range of 3 to 5. If n is 3, a 6-membered ring is formed of phosphorus (P) elements and nitrogen (N) elements. If n is 4, an 8-membered ring is formed of phosphorus (P) elements and nitrogen (N) elements. Even if n is 5 or more, a ring structure is formed in the same manner. R₁₉ and R₂₀ each independently represent an organic group such as a substituted or unsubstituted phenoxy group and a substituted or unsubstituted naphthoxy group (for example, a β-naphthoxy group).

Examples of the phosphazene derivatives include cyclophosphazene compounds having a phenoxy group, cyclophosphazene compounds having a cyanophenoxy group, cyclophosphazene compounds having an aminophenoxy group and cyclophosphazene compounds having a substituted or unsubstituted naphthoxy group. Among these cyclophosphazene compounds, preferable are cyclotriphosphazene, cyclotetraphosphazene and cyclopentaphosphazene which have a substituted or unsubstituted phenoxy group or a substituted or unsubstituted naphthoxy group; and especially preferable is cyclotriphosphazene having a substituted or unsubstituted phenoxy group. Specific examples thereof include hexaphenoxycyclotriphosphazene (the phenoxy group may have a substituent). It is preferable that the cyclophosphazene compound, since being liable to form a quinone structure causing coloration due to oxidation, have no phenolic hydroxyl group. The phosphazene derivatives may be used singly or concurrently in two or more.

The aromatic condensed phosphate esters include 1,3-phenylene bis(di-2,6-xylenylphosphate), resorcinol bisdiphenylphosphate, bisphenol A, bisdiphenylphosphate, resorcinol-bis-2,6-xylenylphosphate, resorcinol-bis-2,6-bisdiphenylphosphate, biphenol-bisphenylphosphate and 4,4′-bis(diphenylphosphoryl)-1,1′-biphenyl.

The content of the flame retardant is preferably determined while checking the effect. In view of fogging resistance, flame retardance, bending breaking strain, impact resistance, heat resistance and bleed resistance, the content of the flame retardant with respect to the polylactic acid resin composition preferably is in the range of 0.5% by mass to 20% by mass, more preferably within the range of 1% by mass to 15% by mass, and further preferably within the range of 2% by mass to 10% by mass.

The polylactic acid resin composition according to an exemplary embodiment may further contain a fluorine-containing polymer forming a fibrous structure (fibrillar structure) in the polylactic acid resin composition. If a fluorine-containing polymer is blended, an effect of suppressing drip phenomenon during burning can be enhanced.

Examples of the fluorine-containing polymer include polytetrafluoroethylene, tetrafluoroethylene copolymers (for example, tetrafluoroethylene-hexafluoropropylene copolymers) and partially fluorinated polymers. Further as the fluorine-containing polymer, there can also be used fluoropolymers of various forms such as fine powdery fluoropolymers, aqueous dispersions of fluoropolymers, mixtures of powdery fluoropolymer and acrylonitrile-styrene copolymer, and mixtures of powdery fluoropolymer and polymethyl methacrylate.

The content of the fluorine-containing polymer, with respect to the polylactic acid resin composition, can be set at 0.05% by mass or higher, and can further be set at 0.1% by mass or higher, and is preferably 0.2% by mass or higher. Further the blend amount of the fluorine-containing polymer, with respect to the polylactic acid resin composition, can preferably be set at 5% by mass or smaller, and is preferably 2% by mass or smaller, and can be set at 1% by mass or smaller, and can further be set at 0.8% by mass or smaller. When the blend amount of the fluorine-containing polymer is 0.05% by mass or larger, the dripping preventing effect in combustion can stably be attained. When the blend amount of the fluorine-containing polymer is 0.1% by mass or larger, the flame retardancy of the polylactic acid resin composition becomes much better. When the blend amount of the fluorine-containing polymer is 5% by mass or smaller, since the fluorine-containing polymer is easily dispersed in the resin, it becomes easy to be homogeneously mixed with the polylactic acid resin composition and the stable production of the resin composition having flame retardancy becomes enabled. When the blend amount of the fluorine-containing polymer is 1% by mass or smaller, the flame retardancy of the polylactic acid resin composition becomes much better; and when the blend amount of the fluorine-containing polymer is 0.8% by mass or smaller, the flame retardancy of the polylactic acid resin composition is further improved.

The polylactic acid resin composition according to an exemplary embodiments may comprise, in the range of not inhibiting their function, various types of additives such as crystal nucleating agents, a plasticizer thermal stabilizers, antioxidants, colorants, fluorescent whitening agents, fillers, mold release agents, softening materials and antistatic agents, impact resistance improving agents, heat-absorbing agents such as metal hydroxides and borate salts, nitrogen compounds such as melamine, halogen-containing flame retardants, and the like.

In the case where the polylactic acid resin composition according to an exemplary embodiment comprises a crystalline resin, in molding molded articles, in order to more promote crystallization of amorphous contents, which have low flow beginning temperatures, use of a crystal nucleating agent is preferable. The crystal nucleating agent itself, in molding molded articles, makes crystal nuclei, which act so that the constituting molecules of the resin are arranged in a regular three-dimensional structure and can achieve the improvements in moldability of the molded articles, the shortening of the molding time, the improvements in the mechanical strength and the heat resistance. Further the crystal nucleating agent, since promoting the crystallization of amorphous contents, even in the case where the mold temperature in molding is high, suppresses deformation of the molded articles, which can make easy the mold release after molding. Even in the case where the mold temperature is higher than the glass transition temperature (Tg) of the resin, the same effect can be attained.

As the crystal nucleating agent, an inorganic crystal nucleating agent and an organic crystal nucleating agent are mentioned.

As the inorganic crystal nucleating agent, there can be used talc, calcium carbonate, mica, boron nitride, synthetic silicic acid, silicate, silica, kaolin, carbon black, zinc white, montmorillonite, clay mineral, basic magnesium carbonate, quartz powder, glass fiber, glass powder, diatomite, dolomite powder, titanium oxide, zinc oxide, antimony oxide, barium sulfate, calcium sulfate, alumina, calcium silicate, boron nitride, and the like.

Examples of the organic crystal nucleating agent include:

(1) organic carboxylic acids: octylic acid, toluic acid, heptanoic acid, pelargonic acid, lauric acid, myristic acid, palmitic acid, stearic acid, behenic acid, cerotic acid, montanic acid, melissic acid, benzoic acid, p-tert-butylbenzoic acid, terephthalic acid, monomethyl terephthalate, isophthalic acid, monomethyl isophthalate, rosin acid, 12-hydroxystearic acid, cholic acid, and the like;
(2) organic carboxylic acid alkali metal salts and organic carboxylic acid alkali earth metal salts: alkali metal salts and alkaline earth metal salts of the organic carboxylic acids, and the like;
(3) polymeric organic compounds having a metal salt of a carboxyl group: metal salts of carboxyl group-containing polyethylenes obtained by oxidation of polyethylene, carboxyl group-containing polypropylenes obtained by oxidation of polypropylene, copolymers of olefins such as ethylene, propylene, butene-1 and the like with acrylic acid or methacrylic acid, copolymers of styrene with acrylic acid or methacrylic acid, copolymers of olefins with maleic anhydride, copolymers of styrene with maleic anhydride, and the like;
(4) aliphatic carboxylic acid amides: oleic acid amide, stearic acid amide, erucic acid amide, behenic acid amide, N-oleylpalmitoamide, N-stearylerucic acid amide, N,N′-ethylenebis(stearoamide), N,N′-methylenebis(stearoamide), methylolstearoamide, ethylenebisoleic acid amide, ethylenebisbehenic acid amide, ethylenebisstearic acid amide, ethylenebislauric acid amide, hexamethylenebisoleic acid amide, hexamethylenebisstearic acid amide, butylenebisstearic acid amide, N,N′-dioleylsebacic acid amide, N,N′-dioleyladipic acid amide, N,N′-distearyladipic acid amide, N′-distearylsebacic acid amide, m-xylylenebisstearic acid amide, N,N′-distearylisophthalic acid amide, N,N′-distearylterephthalic acid amide, N-oleyloleic acid amide, N-stearyloleic acid amide, N-stearylerucic acid amide, N-oleylstearinamide, N-stearylstearic acid amide, N-butyl-N′-stearylurea, N-propyl-N′-stearylurea, N-allyl-N′-stearylurea, N-phenyl-N′-stearylurea, N-stearyl-N′-stearylurea, dimethyl tall oil amide, dimethyllauric acid amide, dimethylstearic acid amide, N,N′-cyclohexanebis(stearoamide), N-lauroyl-L-glutamic acid-α-γ-n-butylamide, and the like;
(5) polymeric organic compounds: 3-position-branched α-olefins having 5 or more carbon atoms such as 3,3-dimethylbutene-1,3-methylbutene-1,3-methylpentene-1,3-methylhexene-1,3,5,5-trimethylhexene-1, polymers of vinylcycloalkanes such as vinylcyclopentane, vinylcyclohexane and vinylnorbornane, polyalkylene glycols such as polyethylene glycol and polypropylene glycol, polyglycolic acid, cellulose, cellulose esters, cellulose ethers, polyester, polycarbonate, and the like;
(6) organic compounds of phosphoric acid or phosphorous acid, and metal salts thereof: diphenyl phosphate, diphenyl phosphite, bis(4-tert-butylphenyl) sodium phosphate, methylene(2,4-tert-butylphenyl) sodium phosphate, and the like;
(7) sorbitol derivatives such as bis(p-methylbenzylidene)sorbitol and bis(p-ethylbenzylidene) sorbitol;
(8) cholesterol derivatives such as cholesteryl stearate and cholesteryloxystearamide;
(9) thioglycolic anhydride, paratoluenesulfonic acid, paratoluenesulfonic acid amide, metal salts thereof, and the like; and
(10) phenylphosphonic acid, metal salts thereof, and the like.

Among these, crystal nucleating agents composed of a neutral substance not promoting hydrolysis of polyester are preferable because the decreasing of the molecular weight of the polylactic acid resin composition undergoing hydrolysis can be suppressed. Then in order to suppress the reduction in molecular weight by the transesterification of the polylactic acid resin composition, esters and amide compounds which are derivatives of crystal nucleating agents are better than crystal nucleating agents having a carboxyl group; and similarly, esters and ether compounds which are derivatives of crystal nucleating agents are better than crystal nucleating agents having a hydroxyl group.

It is preferable that the inorganic crystal nucleating agent be a lamellar compound such as talc, which is codissolved or finely dispersed in a resin in a high-temperature melt state in injection molding or the like, is deposited or phase-separated in a molding cooling stage in a mold, and acts as a crystal nucleating agent.

With respect to the crystal nucleating agent, an inorganic crystal nucleating agent and an organic crystal nucleating agent may be concurrently used, or a plurality of kinds thereof can also be combined and used. The content of the crystal nucleating agent, with respect to the polylactic acid resin composition, can be set in the range of 0.1% by mass to 20% by mass, and can also be set in the range of 0.1% by mass to 10% by mass, and is preferably in the range of 0.2% by mass to 2% by mass.

Examples of the thermal stabilizer and the antioxidant include hindered phenols, phosphorus compounds, hindered amines, sulfur compounds, copper compounds, halides of alkali metals and vitamin E. These are used, with respect to the polylactic acid resin, preferably in the range of 0.5% by mass or less.

Examples of the filler include glass beads, glass flakes, talc powder, clay powder, mica, wollastonite powder and silica powder.

As the impact modifier, a flexible component can be used. Examples of the flexible component that can be used include a polymer block (copolymer) such as a polyester segment, a polyether segment and a polyhydroxycarboxylic acid segment; a block copolymer obtained by mutually binding a polylactic acid segment, an aromatic polyester segment and a polyalkylene ether segment; a block copolymer consisting of a polylactic acid segment and a polycaprolactone segment; a polymer containing an unsaturated carboxylic acid alkyl ester unit as a main component; aliphatic polyester such as polybutylene succinate, polybutylene succinate adipate, polyethylene succinate, polycaprolactone, polyethylene adipate, polypropylene adipate, polybutylene adipate, polyhexene adipate and polybutylene succinate adipate; and plasticizers such as polyethylene glycol and a ester thereof, polyglycerin acetic acid ester, epoxidized soybean oil, epoxidized linseed oil, epoxidized linseed oil fatty acid butyl, adipic acid aliphatic polyester, tributyl acetylcitrate, acetyl ricinoleic acid ester, sucrose fatty acid ester, sorbitan fatty acid ester, adipic acid dialkyl ester and alkyl phthalyl alkyl glycolate.

The polylactic acid resin composition according to an exemplary embodiment, if necessary, may further contain another thermoplastic resin such as polybutylene succinate, polybutylene succinate adipate, polypropylene, polystyrene, ABS, nylon, polyethylene terephthalate, polybutylene terephthalate, polycarbonate and an alloy thereof.

As a crystalline thermoplastic resin, polybutylene succinate, polybutylene succinate adipate, polypropylene, nylon, polyethylene terephthalate, polybutylene terephthalate or an alloy of any one of these with a polylactic acid resin as mentioned above is preferably used.

The polylactic acid resin composition according to an exemplary embodiment may further contain a thermosetting resin such as a phenol resin, a urea resin, a melamine resin, an alkyd resin, an acrylic resin, an unsaturated polyester resin, a diallyl phthalate resin, an epoxy resin, a silicone resin, a cyanate resin, an isocyanate resin, a furan resin, a ketone resin, a xylene resin, a thermosetting polyimide, a thermosetting polyamide, a styryl pyridine resin, a nitrile terminal resin, an addition cure quinoxaline and an addition cure polyquinoxaline resin; and a thermosetting resin using a plant material such as lignin, hemicellulose and cellulose. If a thermosetting resin as mentioned above is used, a curing agent and a cure accelerator required for a curing reaction are preferably used.

The polylactic acid resin composition according to an exemplary embodiment can be produced, for example, as follows: first, a polylactic acid resin, an aliphatic polyester resin, a carbodiimide compound and a metal hydrate as mentioned above and, if necessary, other components such as an additive(s) are mixed and stirred. For mixing/stirring, the same apparatus as a machine (described later) applying shearing force used in producing a polylactic acid resin can be used.

With regard to the polylactic acid resin, a polylactic acid compound as mentioned above may be blended as the polylactic acid resin component.

The polylactic acid resin may be produced as a reaction product between a polylactic acid compound as mentioned above and an amino group-containing polysiloxane compound as mentioned above in the mixing step.

The polylactic acid resin can be obtained by blending, for example, an amino group-containing polysiloxane compound as mentioned above and a polylactic acid compound as mentioned above so as to contain the amino group in a predetermined proportion and mixing and stirring while applying shearing force in a molten state. Note that, in order to react the polylactic acid compound and the amino group-containing polysiloxane compound without fail, these are mixed and stirred while applying shearing force in a molten state to obtain a master batch before other additives are mixed, and then, other components and additive(s) may be added to the master batch and kneaded in a molten state.

Shearing force can be applied to the molten polylactic acid compound and the amino group-containing polysiloxane compound by using, for example, an apparatus such as a roll, an extruder, a kneader, a batch kneader equipped with a reflux apparatus. As the extruder, a single screw extruder or a multi-screw extruder with a vent is preferably employed since materials are easily supplied and a product is easily taken out. The temperature at the time of shearing is at least the melt flow temperature of a raw material, i.e., a polylactic acid compound, preferably, higher by 10° C. or more than the melt flow temperature and not more than the decomposition temperature of the polylactic acid compound. The shearing time for a molten material, for example, falls preferably within the range of 0.1 minutes to 30 minutes and more preferably within the range of 0.5 minutes to 10 minutes. If the shearing time for a molten material is 0.1 minutes or more, a polylactic acid compound as mentioned above and an amino group-containing polysiloxane compound as mentioned above can be sufficiently reacted. If the shearing time for a molten material is 30 minutes or less, decomposition of the resultant polylactic acid resin can be suppressed. The temperature at the time of shearing when an additional resin such as a polyester resin is added, is preferably not less than the melting temperature of the additional resin and not less than the melt flow temperature of the polylactic acid compound; and preferably not more than the decomposition temperature of the additional resin and not more than the decomposition temperature of the polylactic acid compound.

A polylactic acid compound as mentioned above can be produced by melt polymerization method or a combination of a melt polymerization method and a solid phase polymerization method. In these methods, the melt flow rate of a polylactic acid compound as mentioned above is controlled to fall within a predetermined range. If the melt flow rate is excessively large, a method of increasing the molecular weight of a resin by using a small amount of a chain extender such as a diisocyanate compound, an epoxy compound and an acid anhydride, can be used. In contrast, if the melt flow rate is excessively small, a method of mixing a biodegradable polyester resin or a low molecular weight compound having a large melt flow rate can be used.

According to an exemplary embodiment, a molded article can be obtained by molding the polylactic acid resin composition. As a molding method for obtaining a molded article, for example, injection molding, injection/compression molding, extrusion molding and metallic molding can be used. During or after the molding step, it is preferable to facilitate crystallization in order to obtain a molded article excellent in impact resistance and mechanical strength. As a method for facilitating crystallization, a crystal nucleating agent as mentioned above is used within the range as mentioned above.

A molded article thus obtained has excellent fogging resistance, high flame retardance, and excellent impact resistance, flexibility and mechanical strength and is suppressed in deterioration by bleeding. Thus, the molded article is suitably used as various electrical, electronic and automobile parts.

### EXAMPLES

Now, Examples of the present invention will be explained together with Comparative Examples. Note that, the present invention is not limited by the following Examples and Comparative Examples. The details about the raw materials used in Examples and Comparative Examples of the present invention are as follows:

1. Polylactic Acid Compound (PLA): Product Name: INGEO 3251D (Melting Point: 170° C.), Manufactured by Nature Works LLC.

2. Aliphatic Polyester Resin

As the aliphatic polyester resin, the following was used.

Polybutylene succinate adipate (PBSA): product name: BIONOLLE (3001MD), manufactured by Showa Denko K.K.

3. Amino Group-Containing Polysiloxane Compound (C)

As the amino group-containing polysiloxane compound (C), the following was used.

C1-4: a side-chain di-amino-type polysiloxane compound (product name: FZ-3705, manufactured by Dow Corning Toray Co., Ltd.)

(viscosity (25° C.): 230 mm²/s, amino equivalent: 4000 (g/mol), content of an amino group: 0.40% by mass)

Note that, an amino group-containing polysiloxane compound can be produced in accordance with, for example, the description of Silicone Handbook, Nikkan Kogyo Shimbun (1990), p. 165. More specifically, an amino group-containing polysiloxane compound can be synthesized from a siloxane oligomer, which is obtained by hydrolysis of aminoalkylmethyldimethoxysilane, and cyclic siloxane in the presence of a basic catalyst.

4. Organic Crystal Nucleating Agent (E)

As the organic crystal nucleating agent (E), the following was used.

E: Zinc phenylphosphonate (product name: ECO-PROMOTE, manufactured by Nissan Chemical Industries, Ltd.)

5. Phosphorus Flame Retardant (G)

As the phosphorus flame retardant (G), the followings were used.

G-1: Condensed phosphoric acid ester: 1,3-Phenylene bis(di-2,6-xylenyl phosphate) (product name: PX-200, manufactured by DAIHACHI CHEMICAL INDUSTRY CO., LTD.)

G-2: Cyclic phenoxyphosphazene (product name: SPS-100, manufactured by Otsuka Chemical Co., LTD.)

G-3: Condensed phosphoric acid ester: Cresyl-2,6-xylenyl phosphate (product name: PX-110, manufactured by DAIHACHI CHEMICAL INDUSTRY CO., LTD.)

6. Metal Hydrate (I)

As the metal hydrate (I), the followings were used.

I-1: Aluminum hydroxide (product name: BE023, manufactured by Nippon Light Metal Company, Ltd.)

(average particle diameter: 3.1 μm, composition: Al(OH)3 (99.94%), SiO₂ (0.01%), Fe₂O₃ (0.01%), Na₂O (0.04%, alkali metal substance))

I-2: Aluminum hydroxide treated with a 1% isocyanate silane coupling agent (product name: BE023-STI, manufactured by Nippon Light Metal Company, Ltd.,)

(average particle diameter: 3.1 μm, composition: Al(OH)₃ (99.94%), SiO₂ (0.01%), Fe₂O₃ (0.01%), Na₂O (0.04%, alkali metal substance))

(the amount of the silane coupling agent with respect to aluminum hydroxide before treatment: 1% by mass)

I-3: Aluminum hydroxide treated with an 1.3% aminosilane coupling agent

(average particle diameter: 3.1 μm, composition: Al(OH)₃ (99.94%), SiO₂ (0.01%), Fe₂O₃ (0.01%), Na₂O (0.04%, alkali metal substance))

(the amount of the silane coupling agent with respect to aluminum hydroxide before treatment: 1.3% by mass)

Aluminum hydroxide I-3 was prepared as follows.

Aluminum hydroxide I-3 was obtained by previously stirring aluminum hydroxide (product name: BE023) manufactured by Nippon Light Metal Company, Ltd. by a super mixer and spraying an aminosilane coupling agent (product name: KBE-903) manufactured by Shin-Etsu Chemical Co., Ltd. into the aluminum hydroxide in a ratio of 1.35% by mass with respect to aluminum hydroxide, followed by drying.

I-4: Aluminum hydroxide treated with a 1.3% ureide silane coupling agent

(average particle diameter: 3.1 μm, composition: Al(OH)₃ (99.94%), SiO₂ (0.01%), Fe₂O₃ (0.01%), Na₂O (0.04%, alkali metal substance))

(the amount of the silane coupling agent with respect to aluminum hydroxide before treatment: 1.3% by mass)

Aluminum hydroxide I-4 was prepared as follows.

Aluminum hydroxide I-4 was obtained by previously stirring aluminum hydroxide (product name: BE023) manufactured by Nippon Light Metal Company, Ltd. by a super mixer and spraying a ureide silane coupling agent (product name: KBE-585, alcohol solution, silane coupling agent content: about 45% by mass) manufactured by Shin-Etsu Chemical Co., Ltd. into the aluminum hydroxide in a ratio of 2.5% by mass with respect to the aluminum hydroxide, followed by drying.

I-5: Aluminum hydroxide treated with an epoxy silane coupling agent (product name: BE023-STE, manufactured by Nippon Light Metal Company, Ltd.)

(average particle diameter: 3.1 μm, composition: Al(OH)₃ (99.94%), SiO₂ (0.01%), Fe₂O₃ (0.01%), Na₂O (0.04%, alkali metal substance))

(the amount of the silane coupling agent with respect to aluminum hydroxide before treatment: 1% by mass)

I-6: Aluminum hydroxide treated with a methacryloxysilane coupling agent (product name: BE023-STM, manufactured by Nippon Light Metal Company, Ltd.)

(average particle diameter: 3.1 μm, composition: Al(OH)₃ (99.94%), SiO₂ (0.01%), Fe₂O₃ (0.01%), Na₂O (0.04%, alkali metal substance))

(the amount of the silane coupling agent with respect to aluminum hydroxide before treatment: 1% by mass)

I-7: Aluminum hydroxide treated with a vinyl silane coupling agent (product name: BE023-STV, manufactured by Nippon Light Metal Company, Ltd.,)

(average particle diameter: 3.1 μm, composition: Al(OH)₃ (99.94%), SiO₂ (0.01%), Fe₂O₃ (0.01%), Na₂O (0.04%, alkali metal substance))

(the amount of the silane coupling agent with respect to aluminum hydroxide before treatment: 1% by mass)

I-8: Aluminum hydroxide treated with stearic acid (product name: BE023-S, manufactured by Nippon Light Metal Company, Ltd.)

(average particle diameter: 3.1 μm, composition: Al(OH)₃ (99.94%), SiO₂ (0.01%), Fe₂O₃ (0.01%), Na₂O (0.04%, alkali metal substance))

(the amount of stearic acid with respect to aluminum hydroxide before treatment: 1% by mass)

8. Carbodiimide Compound (K)

As the carbodiimide compound (K), the followings were used.

K-1: Polycarbodiimide-based modifier (product name: Carbodilite LA-1, manufactured by Nisshinbo Chemical Inc.)

K-2: Poly(1,3,5-triisopropylphenylene carbodiimide) (product name: Stavaxol P, manufactured by Rhein Chemie)

### Examples 1 to 9 and Comparative Examples 1 to 17

A polylactic acid compound (PLA), if necessary, an aliphatic polyester resin, an organic crystal nucleating agent (E), a phosphorus flame retardant (G), a metal hydrate (I) and a carbodiimide compound (K) were dry-blended in accordance with a blending ratio shown in Tables 2 to 6.

The resultant mixture was supplied to a continuous kneading extruder (ZE40A×40D, L/D=40, a screw diameter ϕ40, manufactured by Berstorff GmbH) having a cylinder temperature of 200° C. through a hopper opening. If necessary, an amino group-containing polysiloxane compound (C1-4) was introduced in accordance with the blending ratio shown in Tables 2 to 6 separately through vent holes such that a total supply amount per hour becomes 15 to 20 kg. The mixture was mixed and stirred in a molten state while applying shearing force by rotating the screw at a rate of 150 rpm. Thereafter, the mixture was extruded like a strand from a die opening of the extruder. The strand was cooled in water and cut into pellet-like pieces to obtain pellets of the polylactic acid resin composition.

The pellets obtained were dried at 100° C. for 5 hours, and subjected to an injection molding machine (EC20P-0.4A, manufactured by TOSHIBA MACHINE CO., LTD., molding temperature: 200° C., temperature of a mold: 90° C., retention time in a mold: 90 seconds) and molded to obtain test pieces (125 mm×13 mm×3.2 mm, 350 mm×100 mm×2.0 mm, 62.5 mm×13 mm×3.2 mm). The test pieces were evaluated for flame retardance, Izod impact strength and bending property (bending strength, bending elastic modulus, bending breaking strain) in accordance with the methods described below. The evaluation results are shown in Tables 2 to 6.

(Fogging Evaluation)

Fogging was evaluated in accordance with DIN75 201: 1992 Method B “Determination of the windscreen fogging characteristics of trim materials in motor vehicles”. More specifically, fogging was evaluated by a tester (product name: window screen fogging tester WF-2) manufactured by Suga Test Instruments Co., Ltd., as follows.

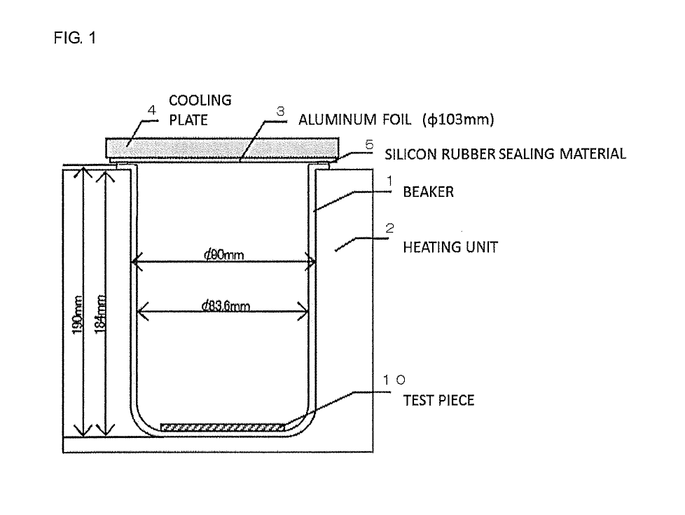

From the test pieces (125 mm×13 mm×3.2 mm) for flame retardance evaluation obtained by injection molding, 10 g of test pieces was taken out and put in a beaker of the tester shown in FIG. 1.

In FIG. 1, a beaker 1 for storing a sample is surrounded by a heating unit 2. A test piece 10 is disposed on the bottom of the beaker 1. The opening of the beaker 1 having the test piece 10 disposed therein is covered with aluminum foil 3. On the aluminum foil, a cooling plate 4 is placed. A silicon rubber sealing material 5 is applied between the aluminum foil and the edge of the opening of the beaker to close the beaker airtight.

Test was carried out at 100±2° C. for 16 hours in the beaker shown in FIG. 1. The temperature of the cooling plate was set to be 20±1° C.

After four hours or more of completion of the test, the mass of the aluminum foil obtained was measured. The mass of the attached material (mg) was obtained based on the difference from the mass of aluminum foil (previously) measured before the test.

(Evaluation of Flame Retardance)

Flame retardance was evaluated in accordance with FMVSS No. 302 flammability test (ISO 3795, JIS D 1201, ASTM D 5132) for automobile interior materials. A flammability tester (model: YST-302S) manufactured by YAMAYO SHIKENKI. COM was used.

More specifically, test pieces (350 mm×100 mm×2.0 mm) for flame retardance evaluation obtained by injection molding were allowed to stand still in a constant-temperature room of 21° C. having a humidity of 50% for 24 hours. Each of the test pieces was horizontally fixed on a U-shape frame (the top of U-shape was turned to the right). Flame of a burner was brought into contact with a portion of the test piece at a distance of 38 mm from the right end for 15 seconds (burning proceeds from right-side marked line A toward left-side marked line B). The burn rate in a zone of 254 mm from marked line A (in a distance of 38 mm from the right end) to marked line B (in a distance of 292 mm from the right end) was obtained and evaluation was made.

(Criteria of FMVSS No. 302 Flammability Test)

A test piece satisfying any one of the following criteria complies FMVSS No. 302 standard.
The test piece is not ignited (non-flammable) or flame is self-extinguished before reaching marked line A
Flame is self-extinguished within 51 mm from an initiation point of burning (and within 60 seconds)
A burn rate of 102 mm/min or less

Note that, individual test standards are summarized in Table 1.

TABLE 1

| | | | | |
|---|---|---|---|---|
| Item | FMVSS No. 302 | ISO 3795 | JIS D 1201 | ASTM D 5132 |

| Presence or absence of | Used if necessary | Required | Optional if necessary |
|---|---|---|---|
| U-shape frame wire | | | |
| Height of flame | 38 mm | 38 ± 1.5 (mm) | 38 ± 2 (mm) |
| Time in contact with flame | 15 seconds | | |
| Size of standard test piece | 356 × 102 (mm) | 356 x 100 (mm) | 355 × 100 (mm) |
| Thickness of test piece | 13 mm or less | | |
| Controlled conditions | 21° C. · | (23 ± 2)° C. · | (23 ± 2)° C. · |
| | 50% RH × | (50 ± 5)% RH × | (50 ± 10)% RH × |
| | 24 h | (24-168) h | 24 h or more |
| Number of repeats of test | Not specified | n = 5 | n = 5 |
| Criteria | Criteria mentioned above | No criteria | No criteria |

(Evaluations of Izod Impact Strength and Bending Properties)

Test pieces were allowed to stand still in a constant-temperature room of 110° C. for one hour. After completely crystallized, the temperature of the test piece was returned to room temperature, and then, Izod impact strength and bending properties were evaluated.

Izod impact strength was measured in accordance with JIS K7110. Notching and impact strength of test pieces (62.5 mm×13 mm×3.2 mm) were measured.

Bending properties were evaluated based on ASTM D790 by using a universal tester (5567, manufactured by Instron).

TABLE 2

| | | | | Comparative | Comparative |
|---|---|---|---|---|---|
| | Example 1 | Example 2 | Example 3 | Example 1 | Example 2 |
| PLA | 45.2% | 45.2% | 43.6% | 56.5% | 56.5% |
| PBSA | 11.3% | 11.3% | 10.9% | — | — |
| I-3 | 40.0% | — | 40.0% | 40.0% | — |
| I-4 | — | 40.0% | — | — | 40.0% |
| G-1 | 2.0% | 2.0% | 2.0% | 2.0% | 2.0% |
| E | 0.5% | 0.5% | 0.5% | 0.5% | 0.5% |
| K-1 | 0.5% | 0.5% | 0.5% | 0.5% | 0.5% |
| K-2 | 0.5% | 0.5% | 0.5% | 0.5% | 0.5% |
| C1-4 | — | — | 2.0% | — | — |
| FMVSS No. 302 (2.0 mmt) | Comply | Comply | Comply | Comply | Comply |
| | (non-flammable) | (non-flammable) | (non-flammable) | (non-flammable) | (non-flammable) |
| Izod impact strength (kJ/m²) | 7.8 | 8.0 | 9.0 | 3.1 | 3.4 |
| Fogging (mg) | 0.2 | 0.2 | 0.4 | 0.2 | 0.2 |
| Bending strength (MPa) | 80.4 | 77.0 | 70.4 | 100.0 | 94.2 |
| Bending elastic modulus (GPa) | 4.3 | 4.2 | 4.7 | 7.0 | 7.1 |
| Bending breaking strain (%) | 5.8 | 6.0 | 8.0 | 1.8 | 1.4 |

As shown in Table 2, from the results of Examples 1 and 2, it was found that a polylactic acid resin composition, which was prepared by blending an aliphatic polyester resin (PBSA), a carbodiimide compound (K) and a metal hydrate (I-3, 4) whose surface was treated with a silane coupling agent with a polylactic acid compound (PLA), occurs fogging but in an extremely small amount and has flame retardance complying with FMVSS NO. 302 and excellent impact strength and bending breaking strain.

From the results of Example 3, it was found that a polylactic acid resin composition, which was prepared by blending, an amino group-containing polysiloxane compound (C1-4), an aliphatic polyester resin (PBSA), a carbodiimide compound (K), and a metal hydrate (I-3) whose surface was treated with an aminosilane coupling agent with a polylactic acid compound (PLA), occurs fogging but in an extremely small amount and has flame retardance complying with FMVSS NO. 302 and excellent impact strength and bending breaking strain.

In contrast, from Comparative Examples 1 and 2, it was found that a polylactic acid resin composition containing no aliphatic polyester resin (PBSA) has flame retardance complying with FMVSS NO. 302 and the amount of fogging satisfies 1 mg or less; however, impact strength and bending breaking strain thereof are extremely low.

TABLE 3

| | Comparative | Comparative | Comparative | | | |
|---|---|---|---|---|---|---|
| | Example 3 | Example 4 | Example 5 | Example 4 | Example 5 | Example 6 |
| PLA | 100% | 43.6% | 42.8% | 42.8% | 42.8% | 37.5% |
| PBSA | — | 10.9% | 10.7% | 10.7% | 10.7% | 16.1% |
| I-1 | — | — | — | — | — | — |
| I-2 | — | 40.0% | 40.0% | 40.0% | 40.0% | 40.0% |
| G-1 | — | 2.0% | 2.0% | 2.0% | 2.0% | 2.0% |
| E | — | 0.5% | 0.5% | 0.5% | 0.5% | 0.5% |
| K-1 | — | — | — | 1.0% | 0.5% | 0.5% |
| K-2 | — | — | 1.0% | — | 0.5% | 0.5% |
| C1-4 | — | 3.0% | 3.0% | 3.0% | 3.0% | 3.0% |
| FMVSS No. 302 (2.0 mmt) | Fail to | Comply | Comply | Comply | Comply | Comply |
| | comply | (non-flammable) | (non-flammable) | (non-flammable) | (non-flammable) | (non-flammable) |
| Izod impact strength (kJ/m²) | 2.5 | 3.1 | 3.8 | 5.5 | 5.2 | 7.2 |
| Fogging (mg) | 1.5 | 1.5 | 1.1 | 0.2 | 0.0 | 0.0 |
| Bending strength (MPa) | — | 42.0 | 56.2 | 61.1 | 60.4 | 56.5 |
| Bending elastic modulus (GPa) | — | 4.2 | 3.7 | 3.7 | 3.2 | 3.0 |
| Bending breaking strain (%) | — | 1.5 | 5.4 | 7.4 | 7.7 | >10 |

As shown in Table 3, from the results of Examples 4 to 6, it was found that a polylactic acid resin composition, which was prepared by blending an amino group-containing polysiloxane compound (C1-4), an aliphatic polyester resin (PBSA), an alicyclic carbodiimide compound (K-1) and a metal hydrate (I-2) whose surface was treated with an isocyanate silane coupling agent with a polylactic acid compound (PLA), occurs fogging but in an extremely small amount and has flame retardance complying with FMVSS NO. 302 and excellent impact strength and bending breaking strain. As is apparent from comparison between Example 4 and Example 5, fogging suppression effect is further improved if an alicyclic carbodiimide compound (K-1) and an aromatic carbodiimide compound (K-2) are used in combination.

In contrast, in Comparative Example 3 using a polylactic acid compound (PLA) alone, Comparative Example 4 containing no carbodiimide compound and Comparative Example 5 using an aromatic carbodiimide compound (K-2) alone, the amount of fogging exceeds 1 mg. Thus, these compositions are not complying with automotive materials.

TABLE 4

| | Comparative | Comparative | Comparative | Comparative | Comparative |
|---|---|---|---|---|---|
| | Example 6 | Example 7 | Example 8 | Example 9 | Example 10 |
| PLA | 54.5% | 53.5% | 53.5% | 53.5% | 53.5% |
| PBSA | — | — | — | — | — |
| I-1 | — | — | — | — | 40.0% |
| I-2 | 40.0% | 40.0% | 40.0% | 40.0% | — |
| G-1 | 2.0% | 2.0% | 2.0% | 2.0% | 2.0% |
| E | 0.5% | 0.5% | 0.5% | 0.5% | 0.5% |
| K-1 | — | 1.0% | — | 0.5% | 0.5% |
| K-2 | — | — | 1.0% | 0.5% | 0.5% |
| C1-4 | 3.0% | 3.0% | 3.0% | 3.0% | 3.0% |
| FMVSS No. 302 (2.0 mmt) | Comply | Comply | Comply | Comply | Comply |
| | (non-flammable) | (non-flammable) | (non-flammable) | (non-flammable) | (non-flammable) |
| Izod impact strength (kJ/m²) | 1.7 | 2.3 | 1.5 | 2.6 | 1.7 |
| Fogging (mg) | 1.2 | 0.4 | 1.1 | 0.7 | 0.4 |
| Bending strength (MPa) | 60.0 | 74.8 | 64.0 | 70.5 | 65.4 |
| Bending elastic modulus (GPa) | 6.4 | 5.9 | 5.5 | 5.0 | 5.3 |
| Bending breaking strain (%) | 1.1 | 2 | 1.8 | 4.0 | 1.8 |

As shown in Table 4, from the results of Comparative Examples 6 to 10, it was found that a polylactic acid resin composition containing no aliphatic polyester resin (PBSA) has flame retardance complying with FMVSS NO. 302 and low fogging (the amount of fogging: 1 mg or less); however, impact strength thereof is extremely low and poor in practical view.

From the results of Comparative Example 10, it was found that a polylactic acid resin composition containing no aliphatic polyester resin (PBSA) and using a metal hydrate (I-1) whose surface is not treated has flame retardance complying with FMVSS NO. 302 and low fogging (the amount of fogging: 1 mg or less); however, impact strength and bending breaking strain thereof are extremely low.

As is apparent from comparison between Comparative Example 9 (Table 4) containing no aliphatic polyester resin (PBSA) and Example 5 (Table 3) containing an aliphatic polyester resin (PBSA), fogging was greatly suppressed by addition of an aliphatic polyester resin (PBSA).

TABLE 5

| | | | | Comparative | Comparative |
|---|---|---|---|---|---|
| | Example 7 | Example 8 | Example 9 | Example 11 | Example 12 |
| PLA | 42.8% | 42.8% | 42.8% | 53.5% | 53.5% |
| PBSA | 10.7% | 10.7% | 10.7% | — | — |
| I-3 | 40.0% | — | — | 40.0% | — |
| I-4 | — | 40.0% | — | — | 40.0% |
| I-5 | — | — | 40.0% | — | — |
| G-1 | 2.0% | 2.0% | 2.0% | 2.0% | 2.0% |
| E | 0.5% | 0.5% | 0.5% | 0.5% | 0.5% |
| K-1 | 0.5% | 0.5% | 0.5% | 0.5% | 0.5% |
| K-2 | 0.5% | 0.5% | 0.5% | 0.5% | 0.5% |
| C1-4 | 3.0% | 3.0% | 3.0% | 3.0% | 3.0% |
| FMVSS No. 302 (2.0 mmt) | Comply | Comply | Comply | Comply | Comply |
| | (non-flammable) | (non-flammable) | (non-flammable) | (non-flammable) | (non-flammable) |
| Izod impact strength (kJ/m²) | 6.3 | 9.2 | 4.0 | 3.3 | 3.3 |
| Fogging (mg) | 0.2 | 0.4 | 0.9 | 0.7 | 0.8 |
| Bending strength (MPa) | 62.4 | 61.0 | 48.5 | 74.0 | 73.4 |
| Bending elastic modulus (GPa) | 3.6 | 3.5 | 2.8 | 5.0 | 4.9 |
| Bending breaking strain (%) | 9.0 | >10 | 8.8 | 2.3 | 2.2 |

As shown in Table 5, from the results of Examples 7 to 9, it was found that polylactic acid resin compositions, which were prepared by blending an amino group-containing polysiloxane compound (C1-4), an aliphatic polyester resin (PBSA), a carbodiimide compound (K), a metal hydrate (I-3) whose surface is treated with an aminosilane coupling agent, a metal hydrate (I-4) whose surface is treated with a ureide silane coupling agent or a metal hydrate (I-5) whose surface is treated with an epoxy silane coupling agent with a polylactic acid compound (PLA), occurs fogging but in an extremely small amount and has flame retardance complying with FMVSS NO. 302 and excellent impact strength and bending breaking strain.

In contrast, from the results of Comparative Examples 11 and 12, it was found that a polylactic acid resin composition containing no aliphatic polyester resin (PBSA) has flame retardance complying with FMVSS NO. 302 and low fogging (the amount of fogging: 1 mg or less); however, impact strength and bending breaking strain thereof are extremely low and poor in practical view.

TABLE 6

| | Comparative | Comparative | Comparative | Comparative | Comparative |
|---|---|---|---|---|---|
| | Example 13 | Example 14 | Example 15 | Example 16 | Example 17 |
| PLA | 42.8% | 37.5% | 42.8% | 42.8% | 42.8% |
| PBSA | 10.7% | 16.1% | 10.7% | 10.7% | 10.7% |
| I-1 | 40.0% | 40.0% | — | — | — |
| I-6 | — | — | 40.0% | — | — |
| I-7 | — | — | — | 40.0% | — |
| I-8 | — | — | — | — | 40.0% |
| G-1 | 2.0% | 2.0% | 2.0% | 2.0% | 2.0% |
| E | 0.5% | 0.5% | 0.5% | 0.5% | 0.5% |
| K-1 | 0.5% | 0.5% | 0.5% | 0.5% | 0.5% |
| K-2 | 0.5% | 0.5% | 0.5% | 0.5% | 0.5% |
| C1-4 | 3.0% | 3.0% | 3.0% | 3.0% | 3.0% |
| FMVSS No. 302 (2.0 mmt) | Comply | Comply | Comply | Comply | Comply |
| | (non-flammable) | (non-flammable) | (non-flammable) | (non-flammable) | (non-flammable) |
| Izod impact strength (kJ/m²) | 3.4 | 3.4 | 2.0 | 2.3 | 1.8 |
| Fogging (mg) | 0.2 | 0.6 | 0.7 | 0.7 | 0.9 |
| Bending strength (MPa) | 51.5 | 51.6 | 52.0 | 50.4 | 50.0 |
| Bending elastic modulus (GPa) | 3.8 | 3.1 | 3.1 | 3.1 | 2.9 |
| Bending breaking strain (%) | 3.3 | 3.4 | 2.2 | 2.4 | 2.1 |

As shown in Table 6, from the results of Comparative Examples 13 to 17, it was found that a polylactic acid resin composition which was prepared by blending an amino group-containing polysiloxane compound (C1-4), an aliphatic polyester resin (PBSA), a carbodiimide compound (K), a metal hydrate (I-1) whose surface is not treated, a metal hydrate (I-6) whose surface is treated with a methacryloxysilane coupling agent, a metal hydrate (I-7) whose surface is treated with a vinyl silane coupling agent, or a metal hydrate (I-8) whose surface is treated with stearic acid, with a polylactic acid compound (PLA) has flame retardance complying with FMVSS NO. 302 and low fogging (the amount of fogging: 1 mg or less); however, impact strength and bending breaking strain thereof are extremely low and poor in practical view.

A part or whole of the above exemplary embodiments can be described as in the following exemplary embodiments; however, they are not limited by the following exemplary embodiments.

### Further Exemplary Embodiment 1

A polylactic acid resin composition containing a polylactic acid resin, an aliphatic polyester resin, a carbodiimide compound and a metal hydrate,

wherein the metal hydrate is a metal hydrate surface-treated with an aminosilane coupling agent, a ureide silane coupling agent, an isocyanate silane coupling agent or an epoxy silane coupling agent, and

the carbodiimide compound comprises an aliphatic carbodiimide compound.

### Further Exemplary Embodiment 2

The polylactic acid resin composition according to embodiment 1,

wherein the content of the polylactic acid resin with respect to the polylactic acid resin composition is in the range of 25% by mass to 60% by mass,

the content of the aliphatic polyester resin with respect to the polylactic acid resin composition is in the range of 5% by mass to 20% by mass,

the content of the metal hydrate with respect to the polylactic acid resin composition is in the range of 30% by mass to 50% by mass, and

the content of the carbodiimide compound with respect to the polylactic acid resin composition is in the range of 0.5% by mass to 3% by mass.

### Further Exemplary Embodiment 3

The polylactic acid resin composition according to embodiment 1 or 2, wherein the carbodiimide compound comprises an alicyclic carbodiimide as the aliphatic carbodiimide compound.

### Further Exemplary Embodiment 4

The polylactic acid resin composition according to any one of embodiments 1 to 3, wherein the carbodiimide compound comprises the aliphatic carbodiimide compound and an aromatic carbodiimide compound.

### Further Exemplary Embodiment 5

The polylactic acid resin composition according to any one of embodiments 1 to 4, wherein the content of an alkali metal substance in the metal hydrate is 0.2% by mass or less.

### Further Exemplary Embodiment 6

The polylactic acid resin composition according to any one of embodiments 1 to 5, further comprising a phosphorus flame retardant, wherein the content of the phosphorus flame retardant with respect to the polylactic acid resin composition is in the range of 1% by mass to 15% by mass.

### Further Exemplary Embodiment 7

The polylactic acid resin composition according to any one of embodiments 1 to 6, further comprising an amino group-containing polysiloxane compound having an amino group in a side chain.

### Further Exemplary Embodiment 8

The polylactic acid resin composition according to embodiment 7, wherein the content of the amino group-containing polysiloxane compound with respect to the polylactic acid resin composition is in the range of 1.5% by mass to 5% by mass.

### Further Exemplary Embodiment 9

The polylactic acid resin composition according to embodiment 7 or 8, wherein the polylactic acid resin is obtained by mixing the amino group-containing polysiloxane compound and a polylactic acid compound,

the content of the amino group is in the range of 0.01% by mass to 2.5% by mass with respect to the amino group-containing polysiloxane compound, and

the content of the amino group is in the range of 3 ppm by mass to 300 ppm by mass with respect to the polylactic acid compound.

### Further Exemplary Embodiment 10

The polylactic acid resin composition according to any one of embodiments 1 to 9, further comprising a crystal nucleating agent, wherein the content of the crystal nucleating agent is in the range of 0.2% by mass to 2% by mass with respect to the polylactic acid resin composition.

### Further Exemplary Embodiment 11

A molded body formed by using the polylactic acid resin composition according to any one of embodiments 1 to 10.

In the foregoing, the present invention has been described with reference to the exemplary embodiments and the Examples; however, the present invention is not limited to the exemplary embodiments and the Examples. Various modifications understandable to those skilled in the art may be made to the constitution and details of the present invention within the scope thereof.

### INDUSTRIAL APPLICABILITY

As described in the above, the polylactic acid resin composition according to an exemplary embodiment of the present invention has high fogging resistance and flame retardance; and excellent impact resistance and flexibility. The polylactic acid resin composition according to an exemplary embodiment of the present invention can be used in a wide variety of products including, but are not particularly limited to, for example, housings of household appliances and OA devices, car trim parts, and the like.

The present application claims the right of priority based on Japanese Patent Application No. 2015-238041 filed Dec. 4, 2015, the entire disclosure of which is incorporated herein by reference.

### REFERENCE SIGNS LIST

1 Beaker
2 Heating unit
3 Aluminum foil
4 Cooling plate
5 Sealing material
10 Test piece

1. A polylactic acid resin composition comprising a polylactic acid resin, an aliphatic polyester resin, a carbodiimide compound and a metal hydrate,
wherein the metal hydrate is a metal hydrate surface-treated with an aminosilane coupling agent, a ureide silane coupling agent, an isocyanate silane coupling agent or an epoxy silane coupling agent, and
the carbodiimide compound comprises an aliphatic carbodiimide compound.

2. The polylactic acid resin composition according to claim 1, wherein the polylactic acid resin has a segment of a polylactic acid compound and a segment of an amino group-containing polysiloxane compound having an amino group in a side chain;
a content of the amino group is in the range of 0.01% by mass to 2.5% by mass with respect to the amino group-containing polysiloxane compound; and
a content of the amino group is in the range of 3 ppm by mass to 300 ppm by mass with respect to the polylactic acid compound.

3. The polylactic acid resin composition according to claim 2, wherein the amino group-containing polysiloxane compound comprises at least one of a compound represented by the following Formula (1) and a compound represented by the following Formula (2): 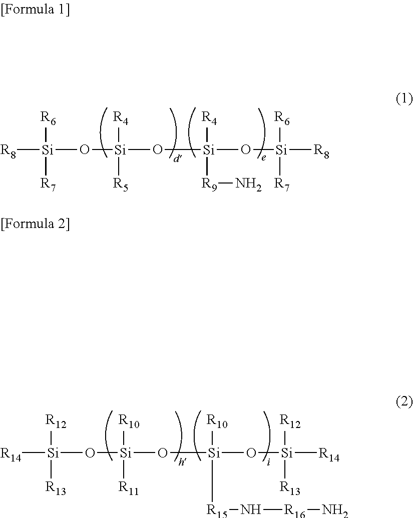
wherein R₄ to R₈ and R₁₀ to R₁₄ each independently represent an alkyl group, an alkenyl group, an aryl group, an aralkyl group, an alkylaryl group having 18 or less carbon atoms or —(CH₂)_{α}—NH—C₆H₅ (α represents an integer of 1 to 8); these may be fully or partially substituted with a halogen atom; R₉, R₁₅ and R₁₆ each independently represent a bivalent organic group; d′ and h′ each represent an integer of 0 or more; and e and i each represent an integer of 1 or more.

4. The polylactic acid resin composition according to claim 1, wherein a content of the aliphatic polyester resin is in the range of 0.05% by mass to 40% by mass with respect to the polylactic acid resin composition.

5. The polylactic acid resin composition according to claim 1, wherein a content of the carbodiimide compound is in the range of 0.05% by mass to 10% by mass with respect to the polylactic acid resin composition.

6. The polylactic acid resin composition according to claim 1,
wherein a content of an alkali metal substance in the metal hydrate is 0.2% by mass or less, and
a content of the metal hydrate is in the range of 0.05% by mass to 50% by mass with respect to the polylactic acid resin composition.

7. The polylactic acid resin composition according to claim 1, further comprising a phosphorus flame retardant, wherein a content of the phosphorus flame retardant is in the range of 0.5% by mass to 20% by mass with respect to the polylactic acid resin composition.

8. The polylactic acid resin composition according to claim 1, wherein a content of the polylactic acid resin is in the range of 25% by mass to 60% by mass with respect to the polylactic acid resin composition.

9. A molded body formed by using the polylactic acid resin composition according to claim 1.

10. A method for producing a polylactic acid resin composition, the method comprising a step of mixing and stirring a mixture comprising a molten-state polylactic acid compound, an aliphatic polyester resin, a carbodiimide compound and a metal hydrate,
wherein the metal hydrate is a metal hydrate surface-treated with an aminosilane coupling agent, a ureide silane coupling agent, an isocyanate silane coupling agent or an epoxy silane coupling agent, and
the carbodiimide compound comprises an aliphatic carbodiimide compound.

11. The polylactic acid resin composition according to claim 1,
wherein the content of the polylactic acid resin with respect to the polylactic acid resin composition is in the range of 25% by mass to 60% by mass,
the content of the aliphatic polyester resin with respect to the polylactic acid resin composition is in the range of 5% by mass to 20% by mass,
the content of the metal hydrate with respect to the polylactic acid resin composition is in the range of 30% by mass to 50% by mass, and
the content of the carbodiimide compound with respect to the polylactic acid resin composition is in the range of 0.5% by mass to 3% by mass.

12. The polylactic acid resin composition according to claim 1, wherein the carbodiimide compound comprises an alicyclic carbodiimide as the aliphatic carbodiimide compound.

13. The polylactic acid resin composition according to claim 1, wherein the carbodiimide compound comprises the aliphatic carbodiimide compound and an aromatic carbodiimide compound.

14. The polylactic acid resin composition according to claim 1, wherein the content of an alkali metal substance in the metal hydrate is 0.2% by mass or less.

15. The polylactic acid resin composition according to claim 1, further comprising a phosphorus flame retardant, wherein the content of the phosphorus flame retardant is in the range of 1% by mass to 15% by mass with respect to the polylactic acid resin composition.

16. The polylactic acid resin composition according to claim 1, further comprising an amino group-containing polysiloxane compound having an amino group in a side chain.

17. The polylactic acid resin composition according to claim 16, wherein the content of the amino group-containing polysiloxane compound with respect to the polylactic acid resin composition is in the range of 1.5% by mass to 5% by mass.

18. The polylactic acid resin composition according to claim 16, wherein the polylactic acid resin is obtained by mixing the amino group-containing polysiloxane compound and a polylactic acid compound,
the content of the amino group is in the range of 0.01% by mass to 2.5% by mass with respect to the amino group-containing polysiloxane compound, and
the content of the amino group is in the range of 3 ppm by mass to 300 ppm by mass with respect to the polylactic acid compound.

19. The polylactic acid resin composition according to claim 1, further comprising a crystal nucleating agent, wherein the content of the crystal nucleating agent is in the range of 0.2% by mass to 2% by mass with respect to the polylactic acid resin composition.
